(19) United States
(12) Patent Application Publication
(10) Pub. No.: US 2007/0276662 A1
(43) Pub. Date: Nov. 29, 2007

(54) Feature-vector compensating apparatus, feature-vector compensating method, and computer product

(75) Inventors: Masami Akamine, Kanagawa (JP); Takashi Masuko, Kanagawa (JP); Daniel Barreda, Kanagawa (JP); Remco Teunen, Kanagawa (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/713,801

(22) Filed: Mar. 5, 2007

(30) Foreign Application Priority Data
Apr. 6, 2006 (JP) 2006-105091

(51) Int. Cl. G10L 15/00

(52) U.S. Cl. 704/233

(57) ABSTRACT

A feature extracting unit extracts a feature vector of an input speech. A similarity calculating unit calculates degrees of similarity for each of a plurality of noise environments, based on the feature vector. A compensation-vector calculating unit acquires a first compensation vector from a storing unit, calculates a second compensation vector based on the first compensation vector, and calculates a third compensation vector by weighting and summing the second compensation vector with the degree of similarity as weights. A compensating unit compensates the feature vector based on the third compensation vector.

### CROSS-REFERENCE TO RELATED APPLICATIONS

This application is based upon and claims the benefit of priority from the prior Japanese Patent Application No. 2006-105091, filed on Apr. 6, 2006; the entire contents of which are incorporated herein by reference.

### BACKGROUND OF THE INVENTION

1. Field of the Invention

The present invention generally relates to a technology for speech processing, and specifically relates to speech processing under a background noise environment.

2. Description of the Related Art

In speech recognition under a noise environment, a mismatch of a speech model causes a problem of degrading a recognition performance due to a difference between a noise environment at a time of learning and a noise environment at a time of recognition. One of the effective methods to cope with the problem is a stereo-based piecewise linear compensation for environments (SPLICE) method proposed in Li Deng, Alex Acero, Li Jiang, Jasha Droppo and Xuedong Huang, “High-performance robust speech recognition using stereo training data”, Proceedings of 2001 International Conference on Acoustics, Speech, and signal Processing, pp. 301-304.

The SPLICE method obtains a compensation vector in advance from a pair of clean speech data and noisy speech data in which a noise is superimposed on the clean speech data, and brings a feature vector at a time of the speech recognition close to a feature vector of the clean speech by using the compensation vector. The SPLICE method can also be viewed as a method of noise reduction.

With such a compensation process, it has been reported that a high recognition rate can be achieved even under a mismatch between training conditions and recognition conditions.

However, the conventional SPLICE method compensates the feature vector only for a single noise environment selected from a number of pre-designed noise environments frame by frame, the noise environment designed in advance does not necessarily match the noise environment at the time of the speech recognition. So a degradation of the recognition performance may be caused by a mismatch of the acoustic model.

Furthermore, because the selection of the noise environment is performed in each frame as short as 10 to 20 milliseconds, a different environment may be selected for each frame even when the same environment is continued for a certain period of time, resulting in a degradation of the recognition performance.

### SUMMARY OF THE INVENTION

According to an aspect of the present invention, a feature-vector compensating apparatus for compensating a feature vector of a speech used in a speech processing under a background noise environment includes a storing unit that stores therein first compensation vectors for each of a plurality of noise environments; an feature extracting unit that extracts a feature vector of an input speech; a similarity calculating unit that calculates degrees of similarity based on extracted feature vector, the degree of similarity indicative of a certainty that the input speech is generated under the noise environment, for each of the noise environments; a compensation-vector calculating unit that acquires the first compensation vector from the storing unit, calculates a second compensation vector that is a compensation vector for the feature vector for each of the noise environments based on acquired first compensation vector, and calculates a third compensation vector by weighting and summing the calculated second compensation vector with the degree of similarity as weights; and a compensating unit that compensates the extracted feature vector based on the third compensation vector.

According to another aspect of the present invention, a method of compensating a feature vector of a speech used in a speech processing under a background noise environment includes extracting a feature vector of an input speech; calculating degrees of similarity based on extracted feature vector, the degree of similarity indicative of a certainty that the input speech is generated under the noise environment, for each of a plurality of noise environments; calculating compensation-vector including acquisition of a first compensation vector from a storing unit that stores therein the first compensation vector for each of the noise environments; calculating a second compensation vector that is a compensation vector for the feature vector for each of the noise environments based on acquired first compensation vector; and calculating a third compensation vector by weighting and summing the calculated second compensation vector with the degree of similarity as weights; and compensating the extracted feature vector based on the third compensation vector.

According to still another aspect of the present invention, a computer program product having a computer readable medium including programmed instructions, wherein the instructions, when executed by a computer, cause the computer to perform extracting a feature vector of an input speech; calculating degrees of similarity based on extracted feature vector, the degree of similarity indicative of a certainty that the input speech is generated under the noise environment, for each of a plurality of noise environments; calculating compensation-vector including acquisition of a first compensation vector from a storing unit that stores therein the first compensation vector for each of the noise environments; calculating a second compensation vector that is a compensation vector for the feature vector for each of the noise environments based on acquired first compensation vector; and calculating a third compensation vector by weighting and summing the calculated second compensation vector with the degree of similarity as weights; and compensating the extracted feature vector based on the third compensation vector.

### BRIEF DESCRIPTION OF THE DRAWINGS

FIG. 1 is a functional block of a feature-vector compensating apparatus according to a first embodiment of the present invention;

FIG. 2 is a flowchart of a feature-vector compensating process according to the first embodiment;

FIG. 3 is a functional block diagram of a feature-vector compensating apparatus according to a second embodiment of the present invention;

FIG. 4 is a flowchart of a feature-vector compensating process according to the second embodiment; and

FIG. 5 is a schematic for explaining a hardware configuration of the feature-vector compensating apparatus according to the first and the second embodiments.

### DETAILED DESCRIPTION OF THE INVENTION

Exemplary embodiments according to the present invention will be explained in detail below with reference to the accompanying drawings.

A feature-vector compensating apparatus according to a first embodiment of the present invention designs in advance compensation vectors for a plurality of noise environments, and stores the compensation vector into a storing unit, calculates a degree of similarity of an input speech with respect to each of the noise environments at a time of a speech recognition, obtains a compensation vector by weighting and summing the compensation vectors of the noise environments based on the calculated degree of similarity, and compensates a feature vector based on the obtained compensation vector.

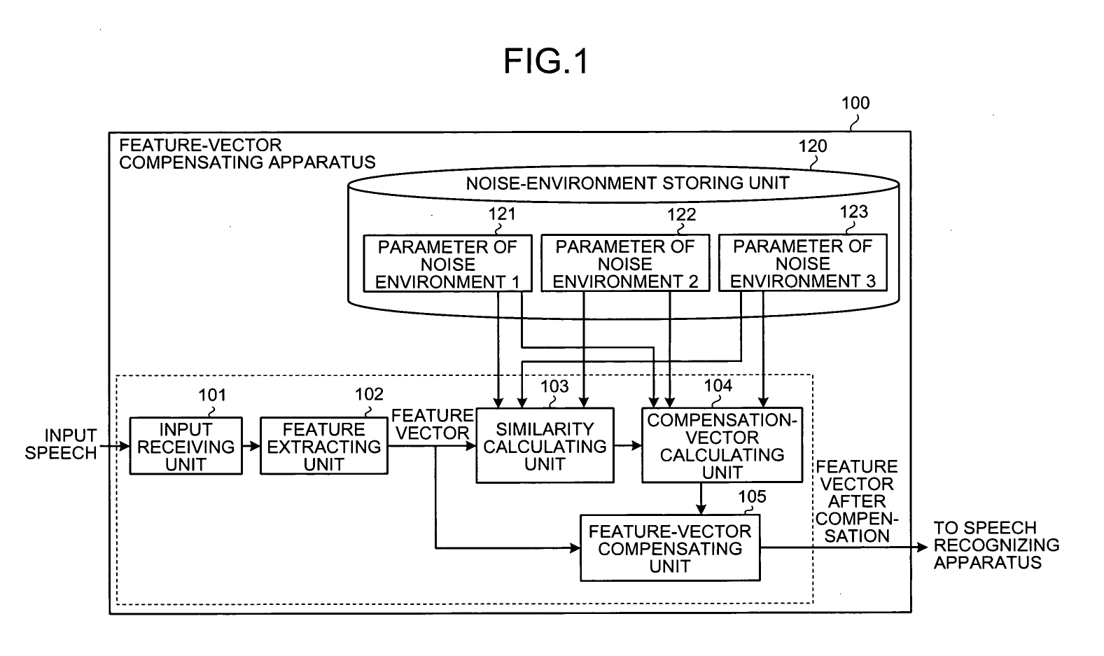

FIG. 1 is a functional block diagram of a feature-vector compensating apparatus 100 according to the first embodiment. The feature-vector compensating apparatus 100 includes a noise-environment storing unit 120, an input receiving unit 101, a feature extracting unit 102, a similarity calculating unit 103, a compensation-vector calculating unit 104, and a feature-vector compensating unit 105.

The noise-environment storing unit 120 stores therein a Gaussian mixture model (GMM) parameter at a time of modeling a plurality of noise environments by the GMM, and compensation vectors calculated in advance as compensation vectors for a feature vector corresponding to each of the noise environments.

According to the first embodiment, it is assumed that parameters of three noise environments including a parameter 121 of a noise environment 1, a parameter 122 of a noise environment 2, and a parameter 123 of a noise environment 3 are calculated in advance, and stored in the noise-environment storing unit 120. The number of noise environments is not limited to three, in other words, any desired number of noise environments can be taken as reference data.

The noise-environment storing unit 120 can be configured with any recording medium that is generally available, such as a hard disk drive (HDD), an optical disk, a memory card, and a random access memory (RAM).

The input receiving unit 101 converts a speech input from an input unit (not shown), such as a microphone, into an electrical signal (speech data), performs an analog-to-digital (A/D) conversion on the speech data to convert analog data into digital data based on, for example, a pulse code modulation (PCM), and outputs digital speech data. The processes performed by the input receiving unit 101 can be implemented by using the same method as a digital processing of the speech signal according to a conventional technology.

The feature extracting unit 102 divides the speech data received from the input receiving unit 101 into a plurality of frames with predetermined lengths, and extracts a feature vector of the speech. The frame length can be 10 to 20 milliseconds. According to the first embodiment, the feature extracting unit 102 extracts the feature vector of the speech which includes static, A, and AA parameters of a Mel frequency cepstrum coefficient (MFCC).

In other words, the feature extracting unit 102 calculates a total of 39-dimensional feature vector including a 13-dimensional MFCC, and A and AA of the MFCC as the feature vector for each of divided frames by using a method of discrete-cosine converting a power of an output of a Mel-scaled filter bank analysis.

The feature vector is not limited to the above one. In other words, any parameter can be used as a feature vector as long as it represents a feature of the input speech.

The similarity calculating unit 103 calculates a degree of similarity for each of the above three noise environments determined in advance, which indicates a certainty that an input speech is generated under each of the noise environments, based on the feature vector extracted by the feature extracting unit 102.

The compensation-vector calculating unit 104 acquires a compensation vector of each noise environment from the noise-environment storing unit 120, and calculates a compensation vector for the feature vector of the input speech by weighting and summing the acquired compensation vectors with the degree of similarity calculated by the similarity calculating unit 103 as weights.

The feature-vector compensating unit 105 compensates the feature vector of the input speech by using the compensation vector calculated by the compensation-vector calculating unit 104. The feature-vector compensating unit 105 compensates the feature vector by adding the compensation vector to the feature vector.

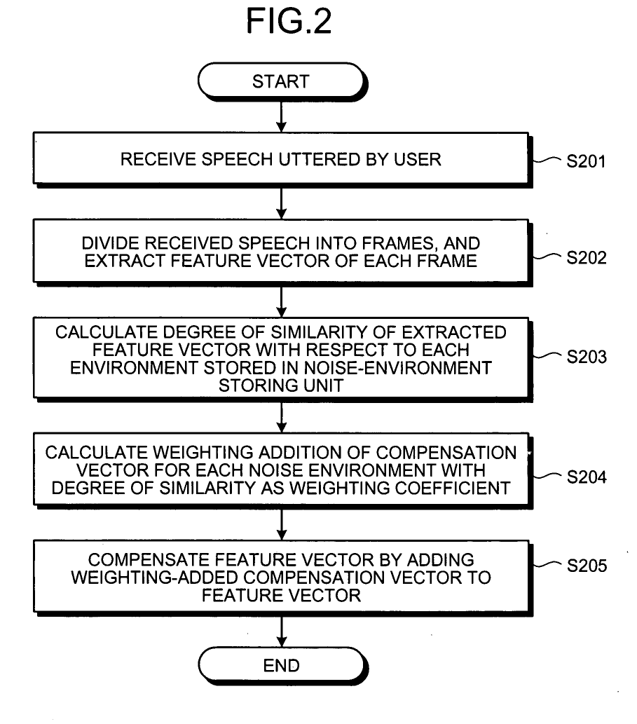

FIG. 2 is a flowchart of a feature-vector compensating process according to the first embodiment.

First of all, the input receiving unit 101 receives an input of a speech uttered by a user (step S201). The input speech is converted into a digital speech signal by the input receiving unit 101.

The feature extracting unit 102 divides the speech signal into frames of 10 milliseconds, and extracts the feature vector of each of the frames (step S202). The feature extracting unit 102 extracts the feature vector by calculating the feature vector yₜ of the MFCC, as described above.

The similarity calculating unit 103 calculates a degree of similarity of a speech of the frame for each of the noise environments determined in advance, based on the feature vector yₜ extracted by the feature extracting unit 102 (step S203). When a model of a noise environment is e, the degree of similarity is calculated as a posterior probability p(e|yₜ) of the noise environment e given the feature vector yₜ at time t as in Equation (1):

$$p \text{(} e \vert {y}_{t} ) = \frac{p ( {y}_{t} \vert e ) p ( e )}{p ( {y}_{t} )} \qquad ( 1 )$$

where p(yₜ|e) is a probability that the feature vector yₜ appears in the noise environment e, and p(e) and p(yₜ) are a prior probability of the noise environment e and a probability of the feature vector yₜ, respectively.

When it is assumed that p(yₜ) is independent of the noise environment, and the prior probability of each of the noise environments is the same, the posterior probability p(e|yₜ) can be calculated using Equation (2):

p(e|yₜ)=αp(yₜ|e) (2)

where p(yₜ|e) and α are calculated using Equations (3) and (4), respectively:

$$p \text{(} {y}_{t} \vert e ) = {\sum }_{s} N ( {y}_{t} ; {μ}_{s}^{e} , {\sum }_{x}^{e} ) p ( s ) . \qquad ( 3 )$$

$$α = \frac{1}{{\sum }_{all e} p ( {y}_{t} \vert e )} \qquad ( 4 )$$

where N is Gaussian distribution, p(s) is a prior probability of each component of the GMM, and the feature vector yₜ is modeled by the GMM. The parameters of the GMM, the mean vector μ and the covariance matrix Σ, can be calculated by using the expectation maximization (EM) algorithm.

The parameters of the GMM can be obtained using a Hidden Markov Model Toolkit (HTK) for a large number of feature vectors prepared in a noise environment as training data. HTK is widely used in speech recognition to train HMMs.

The compensation-vector calculating unit 104 calculates the compensation vector rₜ for the feature vector of the input speech by weighting and summing of the compensation vector rₛ^{e} pre-calculated for each noise environment, using the degree of similarity calculated by the similarity calculating unit 103 as weights (step S204). The compensation vector rₜ is calculated using Equation (5):

$${r}_{t} = {\sum }_{e} p ( e \vert {y}_{t} ) {r}_{t}^{e} \qquad ( 5 )$$

where rₜ^{e} is calculated using

$${r}_{t}^{e} = {\sum }_{s} p ( s \vert {y}_{t} ) {r}_{s}^{e} \qquad ( 6 )$$

Namely, the compensation vector rₜ^{e} of each noise environment e is calculated by weighting and summing of the pre-calculated compensation vector rₛ^{e} based on the same method as a conventional SPLICE method (Equation (6)). Then, the compensation vector rₜ for the feature vector of the input speech is calculated by weighting and summing the compensation vector rₜ^{e} of each noise environment e using the degree of similarity as weights (Equation (5)).

The compensation vector rₛ^{e} can be calculated by the same method as a conventional SPLICE method. For given numerous sets (xₙ, yₙ), where n is a positive integer, xₙ is a feature vector of clean speech data, and yₙ is a feature vector of noisy speech data in each of the noise environments; the compensation vector rₛ^{e} can be calculated using Equation (7), where the superscript “e” representing the noise environment is omitted, as follows:

$${r}_{s} = \frac{{\sum }_{n} p ( s \vert {y}_{n} ) ( {x}_{n} - {y}_{n} )}{{\sum }_{n} p ( s \vert {y}_{n} )} \qquad ( 7 )$$

where p(s|yₙ) is calculated using Equation (8):

$$p \text{(} s \vert {y}_{n} ) = \frac{p ( {y}_{n} \vert s ) p ( s )}{{\sum }_{s} p ( {y}_{n} \vert s ) p ( s )} \qquad ( 8 )$$

The GMM parameters and the compensation vectors calculated in the above manner are stored in the noise-environment storing unit 120 in advance. Therefore, at step S204, the compensation vector rₜ is calculated by using the compensation vector rₛ^{e} of each noise environment stored in the noise-environment storing unit 120.

Finally, the feature-vector compensating unit 105 performs a compensation of the feature vector yₜ by adding the compensation vector rₜ calculated by the compensation-vector calculating unit 104 to the feature vector yₜ calculated at step S202 (step S205).

The feature vector compensated in the above manner is output to a speech recognizing apparatus. The speech processing using the feature vector is not limited to the speech recognition processing. The method according to the present embodiment can be applied to any kind of processing such like speaker recognition.

In this manner, in the feature-vector compensating apparatus 100, an unseen noise environment is approximated with a linear combination of a plurality of noise environments; and therefore, the feature vector can be compensated with an even higher precision, which makes it possible to calculate a feature vector with a high precision even when the noise environment at a time of performing the speech recognition does not match the noise environment at a time of making a design. For this reason, it is possible to achieve a high speech-recognition performance using the feature vector.

In a feature-vector compensating according to the conventional method, in which only one noise environment is selected for each frame of an input speech signal, the performance of a speech recognition becomes greatly degraded when there is an error in selecting the noise environment. On the contrary, the feature-vector compensating method according to the present embodiment linearly combines a plurality of noise environments based on the degree of similarity, instead of selecting only one noise environment; and therefore, even if there is an error in a calculation of the degree of similarity for some reason, an influence on a calculation of the compensation vector is small enough, and as a result, the performance becomes less degraded.

According to the first embodiment, a degree of similarity of a noise environment at each time t is obtained from a feature vector yₜ at the time t alone; however, a feature-vector compensating apparatus according to a second embodiment of the present invention calculates the degree of similarity by using a plurality of feature vectors at times before and after the time t together.

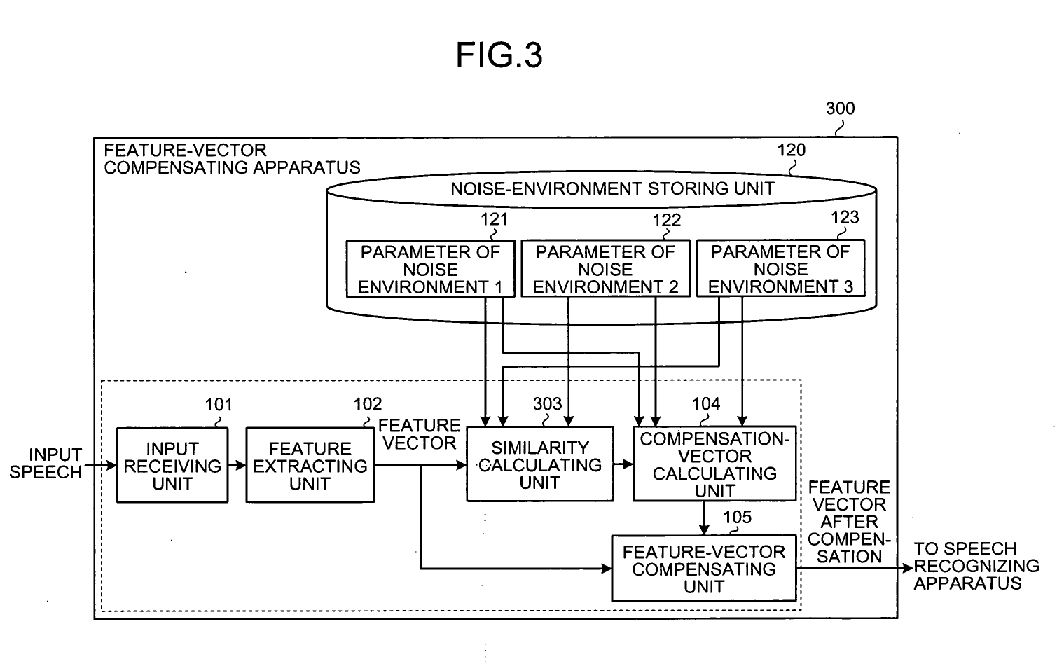

FIG. 3 is a functional block diagram of a feature-vector compensating apparatus 300 according to the second embodiment. The feature-vector compensating apparatus 300 includes the noise-environment storing unit 120, the input receiving unit 101, the feature extracting unit 102, a similarity calculating unit 303, the compensation-vector calculating unit 104, and the feature-vector compensating unit 105.

According to the second embodiment, the function of the similarity calculating unit 303 is different from that of the similarity calculating unit 103 according to the first embodiment. Other units and functions are the same as those of the feature-vector compensating apparatus 100 according to the first embodiment shown in FIG. 1. For those units having the same functions are identified by the same reference numerals, with a detailed explanation omitted.

The similarity calculating unit 303 calculates the degree of similarity by using feature vectors in a time window of plural frames.

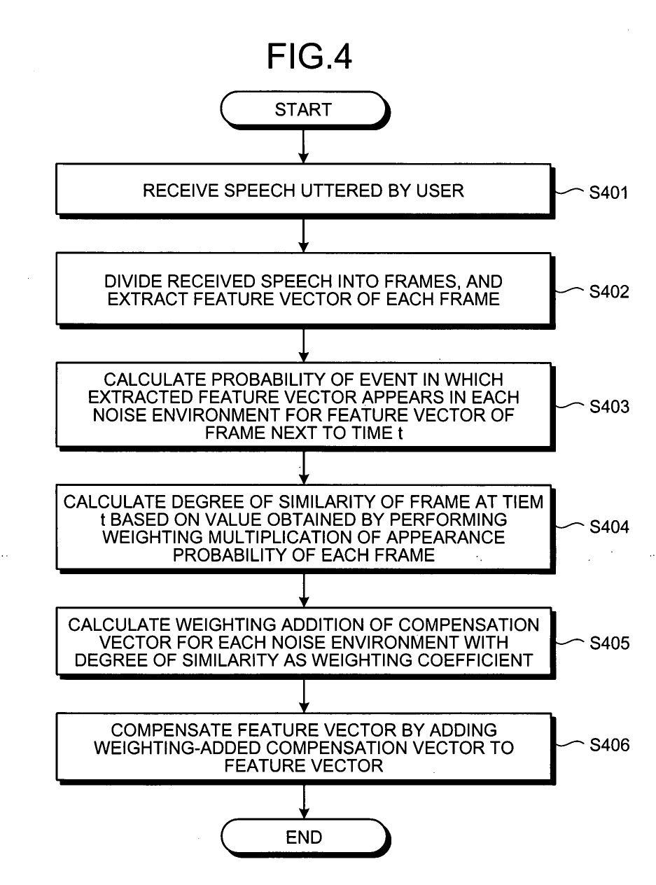

FIG. 4 is a flowchart of a feature-vector compensating process according to the second embodiment.

The processes from step S401 to step S402 are performed in the same way as the processes from step S201 to S202 performed by the feature-vector compensating apparatus 100, so that a detailed explanation will be omitted.

After extracting the feature vector at step S402, the similarity calculating unit 303 calculates a probability of an event in which the extracted feature vectors appear in each noise environment (appearance probability).

Subsequently, the similarity calculating unit 303 calculates a degree of attribution of a frame at the time t by using a value obtained by performing a weighting multiplication of the appearance probability calculated at a frame at each time (step S404). In other words, the similarity calculating unit 303 calculates the degree of similarity p(e|y_{t-a:t+b}) by using Equation (9), where a and b are positive integers, and y_{t-a:t+b} is a feature-vector series from a time t−a to a time t+b.

p(e|y_{t-a:t+b})=αp(y_{t-a:t+b}|e) (9)

where p(y_{t-a:t+b}|e) and α in Equation (9) are calculated by Equations (10) and (11), respectively,

$$\begin{matrix}p \text{(} {y}_{t - a : t + b} \vert e ) = {\prod }_{t = - a}^{b} {( {\sum }_{s} N ( {y}_{t + t} ; {μ}_{s}^{e} , {\sum }_{s}^{e} ) p ( s ) )}^{w ( τ )} & ( 10 ) \\ α = \frac{1}{{\sum }_{all e} p ( {y}_{t - a : t + b} \vert e )} & ( 11 )\end{matrix}$$

where w(τ) is a weight for each time t+τ. A value of w(τ) can be set as, for example, w(τ)=1 for all values of τ, or can be set to be decreased with an increase of an absolute value of τ. Then, the compensation vector rₜ can be obtained, in the same way as Equation (5), using the degree of similarity p(e|y_{t-a:t+b}) calculated in the above manner.

Namely, the compensation-vector calculating unit 104 calculates the compensation vector rₜ, in the same way as step S204 of the first embodiment, using the degree of similarity calculated at step S404 (step S405).

The feature-vector compensating unit 105 compensates the feature vector yₜ by using the compensation vector rₜ, in the same way as step S205 of the first embodiment (step S406), and the process of compensating the feature vector is completed.

In this manner, in the feature-vector compensating apparatus according to the second embodiment, the degree of similarity can be calculated by using a plurality of feature vectors; and therefore, it is possible to suppress an abrupt change of a compensation vector, and to calculate a feature vector with a high precision. For this reason, it is possible to achieve a high speech-recognition performance using the feature vector.

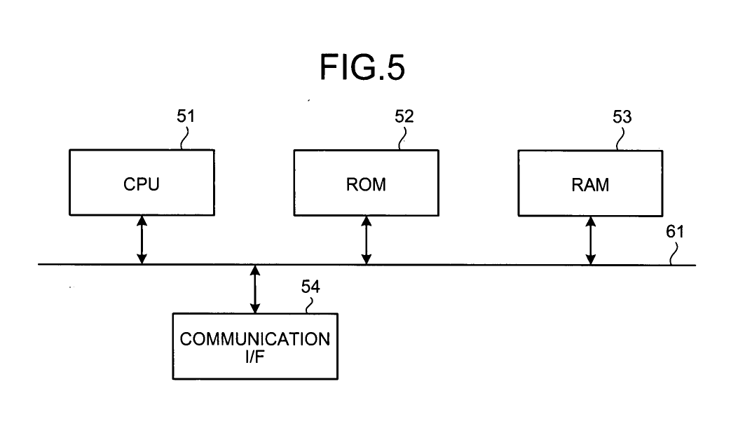

FIG. 5 is a schematic for explaining a hardware configuration of the feature-vector compensating apparatus according to any one of the first and the second embodiments.

The feature-vector compensating apparatus includes a control device such as a central processing unit (CPU) 51, a storage device such as a read only memory (ROM) 52 and a random access memory (RAM) 53, a communication interface (I/F) 54 for performing a communication via a network, and a bus 61 that connects the above components.

A computer program (hereafter, “feature-vector compensating program”) executed in the feature-vector compensating apparatus is provided by a storage device such as the ROM 52 pre-installed therein.

On the contrary, the feature-vector compensating program can be provided by storing it as a file of an installable format or an executable format in a computer-readable recording medium, such as a compact disk-read only memory (CD-ROM), a flexible disk (FD), a compact disk-recordable (CD-R), and a digital versatile disk (DVD).

As another alternative, the feature-vector compensating program can be stored in a computer that is connected to a network such as the Internet, so that the program can be downloaded through the network. As still another alternative, the feature-vector compensating program can be provided or distributed through the network such as the Internet.

The feature-vector compensating program is configured as a module structure including the above function units (the input receiving unit, the feature extracting unit, the similarity calculating unit, the compensation-vector calculating unit, and the feature-vector compensating unit). Therefore, as an actual hardware, the CPU 51 reads out the feature-vector compensating program from the ROM 52 to execute the program, so that the above function units are loaded on a main memory of a computer, and created on the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A feature-vector compensating apparatus for compensating a feature vector of a speech used in a speech processing under a background noise environment, comprising:
a storing unit that stores therein first compensation vectors for each of a plurality of noise environments;
a feature extracting unit that extracts a feature vector of an input speech;
a similarity calculating unit that calculates degrees of similarity based on extracted feature vector, the degree of similarity indicative of a certainty that the input speech is generated under the noise environment, for each of the noise environments;
a compensation-vector calculating unit that acquires the first compensation vector from the storing unit, calculates a second compensation vector that is a compensation vector for the feature vector for each of the noise environments based on acquired first compensation vector, and calculates a third compensation vector by weighting and summing the calculated second compensation vector with the degree of similarity as weights; and
a compensating unit that compensates the extracted feature vector based on the third compensation vector.

2. The apparatus according to claim 1, wherein
the storing unit stores therein parameters obtained when modeling the noise environment with a Gaussian mixture model, and
the similarity calculating unit acquires the parameters from the storing unit, calculates a first likelihood that indicates a certainty that the feature vector appears for each of the noise environments based on acquired parameters, and calculates the degree of similarity based on calculated first likelihood.

3. The apparatus according to claim 1, wherein the compensating unit compensates the feature vector by adding the third compensation vector to the feature vector.

4. The apparatus according to claim 1, wherein the storing unit stores therein the first compensation vector calculated from a noisy speech that is a speech under the noise environment and a clean speech that is a speech under an environment free from the noise, for each of the noise environments.

5. The apparatus according to claim 1, wherein the feature extracting unit extracts a Mel frequency cepstrum coefficient of the input speech as the feature vector.

6. The apparatus according to claim 1, wherein the similarity calculating unit calculates the degree of similarity based on a plurality of feature vectors extracted at a plurality of times within a predetermined range on at least one of before and after a first time.

7. The apparatus according to claim 6, wherein
the storing unit stores therein parameters obtained when modeling the noise environment with a Gaussian mixture model, and
the similarity calculating unit acquires the parameters from the storing unit, calculates a second likelihood that indicates a certainty that the feature vector appears for each of the noise environments for each of the times included in the range based on acquired parameters, calculates a first likelihood that indicates a certainty that the feature vector of the first time appears, by performing a weighting multiplication of calculated second likelihood with a predetermined first coefficient as weights, and calculates the degree of similarity based on calculated first likelihood.

8. The apparatus according to claim 7, wherein the similarity calculating unit calculates the first likelihood that is a product of the calculated second likelihoods, and calculates the degree of similarity based on the calculated first likelihood.

9. The apparatus according to claim 7, wherein the first coefficient is predetermined in such a manner that a value of the first coefficient for a time having a larger difference from the first time is smaller than a value of the first coefficient for a time having a smaller difference from the first time.

10. A method of compensating a feature vector of a speech used in a speech processing under a background noise environment, the method comprising:
extracting a feature vector of an input speech;
calculating degrees of similarity based on extracted feature vector, the degree of similarity indicative of a certainty that the input speech is generated under the noise environment, for each of a plurality of noise environments;
compensation-vector calculating including
acquiring a first compensation vector from a storing unit that stores therein the first compensation vector for each of the noise environments;
calculating a second compensation vector that is a compensation vector for the feature vector for each of the noise environments based on acquired first compensation vector; and
calculating a third compensation vector by weighting and summing the calculated second compensation vector with the degree of similarity as weights; and
compensating the extracted feature vector based on the third compensation vector.

11. A computer program product having a computer readable medium including programmed instructions, wherein the instructions, when executed by a computer, cause the computer to perform:
extracting a feature vector of an input speech;
calculating degrees of similarity based on extracted feature vector, the degree of similarity indicative of a certainty that the input speech is generated under the noise environment, for each of a plurality of noise environments;
compensation-vector calculating including
acquiring a first compensation vector from a storing unit that stores therein the first compensation vector for each of the noise environments;
calculating a second compensation vector that is a compensation vector for the feature vector for each of the noise environments based on acquired first compensation vector; and
calculating a third compensation vector by weighting and summing the calculated second compensation vector with the degree of similarity as weights; and
compensating the extracted feature vector based on the third compensation vector.
